(19) United States
(12) Patent Application Publication
(10) Pub. No.: US 2009/0297904 A1
(43) Pub. Date: Dec. 3, 2009

(54) SOFC Stack

(75) Inventors: Michael Rozumek, Neubrandenburg (DE); Andreas Reinert, Dresden (DE); Michael Stelter, Chemnitz (DE)

Correspondence Address: Maginot Moore & Beck;111 Monument Circle, Chase Tower Suite 3250, Indianapolis, IN, 46204-5109, US

(73) Assignee: Staxera GmbH, Dresden (DE)

(21) Appl. No.: 11/920,640

(22) PCT Filed: May 18, 2006
(86) PCT No.: PCT/DE2006/000853

§ 371 Date: Apr. 6, 2009

(30) Foreign Application Priority Data
May 18, 2005 (DE) 10 2005 022 894.1

(51) Int. Cl. H01M 8/10

(52) U.S. Cl. 429/30

(57) ABSTRACT

The invention relates to a SOFC stack with bipolar plates (5) for connecting the electrodes (3, 4) of two neighboring fuel cells having a ceramic electrolyte, where the bipolar plates (5) have one base plate (6) each, and connected to it, one or more contact elements (7) on one on both sides of the base plate (6). The bipolar plates are characterized in that the base plate (6) is rigid and gas-tight and the contact elements (7) are elastically or plastically deformable, and are arranged or implemented in such a way that they are permeable to gas perpendicularly to the plane of the base plate (6). The bipolar plates (5) mechanically stabilize the SOFC stack and ensure the reliable contacting of the electrodes (3, 4), wherein manufacturing tolerances of the electrodes (3, 4) and relative movements between the components of the stack are compensated by thermal expansion or creep processes.

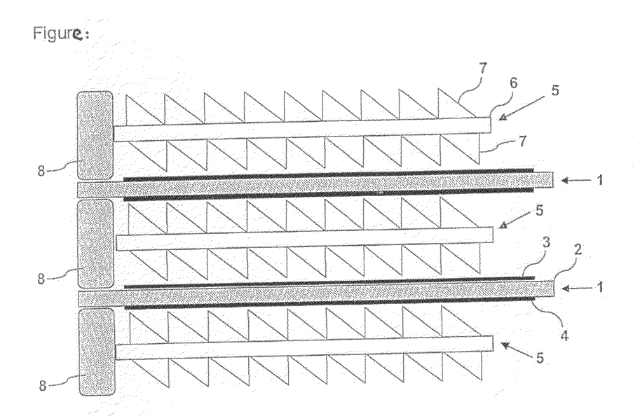

The invention concerns an SOFC stack according to the preamble to Patent claim 1.

A fuel cell stack refers to an arrangement of a number of planar fuel cells. Fuel cells consist of an electrolyte that is conductive to ions, electrodes, and elements for contacting the electrodes and for distributing the fuel over the electrode surface.

Generally speaking, fuel cells are distinguished according to the material of the electrolyte in use, and this also determines the operating conditions and, in particular, the operating temperature. The solid oxide fuel cell (SOFC) used here is operated at temperatures, above 800° C. A ceramic that can conduct O²⁻ ions but that is insulating to electrons is used here as the ion-conductive electrolyte, and is contacted on both sides by two electrodes, the anode and cathode. Yttrium-stabilized zirconium oxide, YSZ, is an example of such a ceramic. The ceramic layers, which, due to their low conductivity, are favorably thin (<50 μm), are used either in a self-supporting form or a form that is not self-supporting, such as what is known as an ASE (anode-supported electrolyte) . Ceramic layers, in some cases with added metal, are again used as the electrodes. The unit consisting of the electrolyte and electrodes is known as an MEA (membrane-electrode assembly), and provides the basis for a fuel cell. Several individual fuel cells are electrically connected in series in a fuel cell stack. For this purpose, an element is incorporated between each pair of MEAs connecting the anode of one MEA with the cathode of the next MEA; the best possible contact over the entire electrode surface is required here. These elements are referred to as bipolar plates, interconnectors or as current collectors.

A reducing fuel, usually containing hydrogen, is supplied to the anode of the fuel cell, while an oxidizing agent such as air is supplied to the cathode. As well as providing an electrical connection between two MEAs, the bipolar plates also separate these gases, and serve to feed and distribute the fuel and the oxidizing agent across the electrode surfaces. For this reason, channels are usually formed on each side of the bipolar plates. At the edge of the fuel cells these channels are typically joined and connected to an external gas supply, and are sealed against the environment.

End plates are used at the two ends of the fuel cell stack. They are often thicker than the bipolar plates in order to give them greater mechanical strength and to permit current to be extracted parallel to the plane of the electrodes, and they only provide channels for the passage of gas on one side. Otherwise, their structure and function is similar to that of the bipolar plates, for which reason comments below that refer to bipolar plates also apply to the end plates, Bipolar plates made of ceramic material or of metal are known to the state of the art. An example of the ceramic material is provided by LaCrO₃, as it has adequate conductivity at the high operating temperatures of the SOFC, and can be matched effectively to the thermal expansion of the electrolyte. The high cost of manufacture resulting from the difficulties of processing ceramic plates of such large areas is disadvantageous. Ferritic alloys may be used as a metallic material for bipolar plates, in which the alloy is selected such that an oxide layer develops on the surface, giving the metal the necessary resistance to corrosion without impairing the electrical conductivity too heavily. Alloys of this type for bipolar plates are known, for instance, from document DE 197 05 874 A1 (aluminum and/or chromium oxide layer), or from document DE 100 50 010 A1 (manganese and/or cobalt oxide layer). In both cases (ceramic and metallic materials) the bipolar plates for an SOFC stack according to the state of the art are rigid and are manufactured with a specified thickness.

Seals, with which the stack is closed off from the surroundings, are a further component of a fuel cell stack. Typically they are located in the same plane as the bipolar plates. Rigid seals made, for instance, of glass solder, are frequently used.

Two different approaches are then commonly taken to combining the individual components (fuel cells, bipolar plates and end plates) to form a stack.

One approach is to bond the stack together with material. A hardenable sealing paste, such as glass solder, is applied around the edge of the individual cells. This sealing paste hardens when the stack is heated in the jointing process, bonding the cells together. The method of improving the contact of the electrodes by applying an additional layer of ceramic paste to the bipolar plates, favorably one with a chemical composition corresponding to that of the electrode being contacted, is known. A paste of this type is known, for instance, from document DE 199 41 282 A1. A disadvantage of this rigidly jointed fuel cell stack is that subsequent shrinkage or spreading of the seals, or fusion or creep of the bipolar plates, can result either in loss of contact or in leakage from the stack. The reason for this is that there are no compensating elements that can absorb changes in the thickness of the seal or of the bipolar plates.

As another approach, a stack can be provided with flexible seals and pressed together; external compensating elements are provided here. An arrangement for an SOFC stack is disclosed in document DE 19645111 C2, in which buffer elements acting as springs are provided to the stack externally on the pre-stressing clamping path. These buffer elements provide an almost constant compression force over a wide range of temperatures. Document US 2002/0142204 A1 presents a rod-shaped compression element for pre-stressing an SOFC stack, in which the combination of materials used achieves a coefficient of thermal expansion matched to that of the stack. In this way it is possible either to keep the contact force constant over a wide range of temperatures, or even to provide a controlled change that depends on temperature. A disadvantage of this solution is that a resilient or compensating element must be fitted externally, as a result of which neither the manufacturing tolerances of the bipolar plates and electrodes can be compensated for, nor can reliable contacting be ensured if the seals are not permanently elastic.

A further approach to assembling the stack is known for low-temperature fuel cells such as the PEMFC (Polymer Electrolyte Membrane Fuel Cell) that is operated at around 100° C., where elastic compensating elements are included within the stack. For instance, such elements include a gauze of graphite fibres inserted between the electrode and the bipolar plate to improve contact, or bipolar plates with a resilient structure. The polymer membrane used as an electrolyte is, moreover, itself elastic. This approach can compensate both for manufacturing tolerances and for thermal expansion of the contact elements, resulting in more reliable contact to the electrodes. At the same time, external compensating elements are not required, as a result of which the structure of the stack is more compact.

At the high operating temperatures of the SOFC only very few materials are permanently elastic, and thereby suitable for use as internal compensating elements. In contrast to the ductile polymer membranes in the PEMFC, the ceramic MEAs in the SOFC are brittle. For this reason a satisfactory implementation of an SOFC stack with internal compensating elements has not until now been achieved.

The task of the invention is therefore to provide an SOFC stack having internal compensating elements that satisfy the above-mentioned requirements and which do not have a negative effect on either the compact construction or the manufacturing costs of the SOFC stack.

This task is fulfilled according to the invention by an SOFC stack with bipolar plates each of which has a base plate and one or more contact elements joined to it on one or both sides of the base plate, characterized in that the base plate is rigid and gas-tight, while the contact elements are elastically or plastically deformable and are so arranged or implemented that they are permeable to gas in the direction perpendicular to the plane of the base plate.

The contact elements of the bipolar plates implement the internal compensating elements according to the invention.

The bipolar plates are rigid on one side as a result of their base plate, which stabilizes the stack and prevents breakage of the MEAs. On the other hand, as a result of the contact elements, they are able to compensate for local differences of thickness resulting from manufacturing tolerances in the electrodes or from thermal expansion, creep processes or similar effects.

The permeability to gas of the contact elements permits the supply of reagent gases to the electrodes. Lateral distribution of the gases can occur between the base plate and the contact element, possibly by means of additional channels incorporated into the base plate.

The integration of internal compensating elements in the bipolar plates means that no additional components have to be included in the stack. Assembly of the stack is thereby not made any more complicated, nor is its compact structure impaired.

Favorable embodiments in respect, for instance, of the geometry and the selection of materials, are the objects of the subsidiary claims.

The invention is described in more detail below with the aid of an embodiment illustrated by a drawing.

The figure shows a schematic cross-sectional drawing of an embodiment of the SOFC stack according to the invention. Only a part of the SOFC stack is represented. The MEAs 1 of two fuel cells are shown. The MEAs 1 each incorporate an electrolyte 2 and two electrodes, the cathode 3 and the anode 4. Between the MEAs 1, i.e. above and below them, are bipolar plates 5 consisting of a base plate 6 and of contact elements 7. Above and below the outer bipolar plates 5 the SOFC stack includes further MEAs 1, not shown here. A rigid seal 8 surrounds the bipolar plates 5 between the individual MEAs 1.

In this embodiment the contact elements 7 are manufactured from expanded metal A ferritic metal is used as the material, to which finely divided, highly dispersive oxides of rare earth metals have been added. Metal alloys of this type are characterized by high elasticity even at high temperatures, as the finely divided additives prevent large-grained recrystallization of the material. A sheet of this material is given suitable cuts and then stretched. A 3-dimensional structure is created in this way that is resilient in the direction perpendicular to the plane of the sheet. When used as a contact element 7, the raised ridges act as contact points, while the holes allow gas to pass through. By varying the arrangement and the length of the cuts, an optimum compromise between the density of contact points and the size of the gas openings can be achieved.

To ensure the best possible distribution of gas, it is also possible to use a number of expanded metal contact elements 7, varying in the positioning and/or size of the gas openings, on top of one another. An arrangement is favorable here in which contact elements 7 located closer to the MEAs have smaller gas openings with a greater density than those resilient elements 7 that are located closer to the bipolar plates 5.

It is favorable for the contact elements 7 to be made of one piece covering the entire electrode surface that is to be contacted. If a number of contact elements 7 are used next to one another or on top of one another, it is favorable for them to be materially bonded, e.g. by welding, to prevent the electrical contact resistance between the individual contact elements 7 from rising as a result of surface oxidation.

A ferritic metal is also used for the base plate 6. The material thickness is selected in such a way that the base plate 6 mechanically stabilizes the stack. The contact elements 7 are materially bonded to both sides of the base plate 6 by means, for instance, of laser welding or spot welding.

Channels for the distribution of the fuel and/or oxidizing agent can be incorporated into the base plate 6. The distribution of the gas can, however, only take place through the open structure of the contact element 7.

To protect the electrodes 3, 4 from damage by any sharp edges on the contact elements 7, protruding peaks can be smoothed by a rolling process after stretching. In this way the contact element is also given a defined thickness. Another option for avoiding the pressure caused by such peaks involves the insertion of additional porous metal foils between the contact elements 7 and the electrodes 3, 4, This also favorably provides higher electrical conductivity in the direction of the plane of the electrodes 3, 4. The metal foils can also, for instance, be bonded to the contact elements 7 by welding.

In the embodiment illustrated, the contact element 7 has elastic properties, and is therefore able to compensate for manufacturing tolerances in the MEAs and relative movements between the components of the stack resulting from thermal expansion or creep processes. Contact difficulties resulting from external influences such as impacts and vibrations are also avoided.

In a further embodiment of the invention, the same effect can be achieved with contact elements 7 that can deform plastically. For this purpose, the porous metal foil welded to the contact elements 7 is materially bonded to the cathode 3 or the anode 4 by means of a hardening ceramic paste in accordance with the state of the art described in the introduction. The ceramic paste can be applied by screen printing or spraying.

In addition to the method of manufacture of the contact element 7 from expanded metal, other ways of fabricating the contact element 7 exist. A metal sheet can, for instance, have holes punched in it and be raised to have a three-dimensional, resilient structure (corrugations, trapezoids etc.). Alternatively, U-shaped cuts can be punched into a sheet, and the tabs created then pushed out of the plane of the sheet to form resilient tongues. Similarly, spiral or circular cuts can be punched and used to form spiral or conical springs. Other implementations, not explicitly mentioned here, based on a plate with a three-dimensional. structure and openings in the material, are conceivable, and can be used with a suitable base plate 6 as the bipolar plate 5 of the SOFC stack according to the invention.

### REFERENCE NUMERALS

1 MEA (Membrane Electrode Assembly)

2 Electrolyte

3 Cathode

4 Anode

5 Bipolar plate

6 Base plate

7 Contact element

8 Seal

1-17. (canceled)

18. An SOFC stack with bipolar plates for connecting the electrodes of two neighboring fuel cells having a ceramic electrolyte, wherein each bipolar plate comprises
a rigid and gas-tight base plate defining a plane,
one or more contact elements connected on one or both sides of the base plate, the contact elements being elastically or plastically deformable, and are arranged or implemented such that they are permeable to gas perpendicularly to the plane of the base plate.

19. An SOFC stack according to claim 18, wherein the material of the base plate is a ferritic steel.

20. An SOFC stack according to claim 18, wherein the base plate consists of a metal that contains additives of highly dispersed oxides of rare earth metals.

21. An SOFC stack according to claim 18, wherein the base plate incorporates channels for the distribution of gas.

22. An SOFC stack according to claim 18, wherein the material of the contact elements is a ferritic steel.

23. An SOFC stack according to claim 18, wherein the contact elements comprise a metal that contains additives of highly dispersed oxides of rare earth metals.

24. An SOFC stack according to claims 18, wherein at least one of the contact elements is fabricated from expanded metal.

25. An SOFC stack according to claim 18 wherein the contact elements comprise corrugated metal plates into which holes have been punched.

26. An SOFC stack according to claim 18, wherein the contact elements comprise a metal sheet out of which resilient tongues have been pushed.

27. An SOFC stack according to claim 18, wherein the base plate and the contact elements are materially bonded together.

28. An SOFC stack according to claim 27, wherein the base plate and the contact elements are welded together.

29. An SOFC stack according to claim 18, further comprising at least one porous metal foil covering entirely the contact elements.

30. An SOFC stack according to claim 29, wherein the at least one porous metal foil is/are materially bonded to the contact elements.

31. An SOFC stack according to claim 30, wherein the at least one porous metal foil and at least one contact element are welded together.

32. An SOFC stack according to claim 29, wherein the at least one porous metal foil and the contact elements are bonded together by an electrically conductive ceramic paste that hardens at the operating temperature of the SOFC stack.

33. An SOFC stack according to claim 32, wherein the at least one porous metal foil and at least one of the connected electrodes are bonded together by an electrically conductive ceramic paste that hardens at the operating temperature of the SOFC stack.

34. An SOFC stack according to claim 33, wherein the ceramic paste has a chemical composition that matches that of at least one of the connected electrodes.

35. An SOFC stack according to claim 32, wherein the ceramic paste has a chemical composition that matches that of at least one of the connected electrodes.
